(19) United States
(12) Patent Application Publication
(10) Pub. No.: US 2012/0208504 A1
(43) Pub. Date: Aug. 16, 2012

(54) FEMTO ACCESS POINT INITIALIZATION AND AUTHENTICATION

(75) Inventors: Jianquan Song, Shenzhen (CN); Tricci So, San Diego, CA (US); Wen Luo, Nanjing (CN); Li Chu, Shenzhen (CN)

(73) Assignees: ZTE (USA) Inc., Richardson, TX (US); ZTE Corporation, Guangdon (CN)

(21) Appl. No.: 13/381,770

(22) PCT Filed: Jul. 1, 2010
(86) PCT No.: PCT/US10/40799

§ 371 Date: Apr. 23, 2012

Related U.S. Application Data
(60) Provisional application No. 61/222,314, filed on Jul. 1, 2009.

(51) Int. Cl. H04W 12/06

(52) U.S. Cl. 455/411

(57) ABSTRACT

A method and apparatus is provided for implementing initial network entry procedures by a Femto access point which is required to be authenticated by the WiMAX network prior to becoming active and operational. The method includes implementing a DNS query to discover an associated server and gateway in an associated Femto network service provider domain and obtaining an IP address for the server and an IP address for the gateway. The method also includes authenticating the Femto access point with the associated Femto network service provider and establishing a secure IP tunnel between the Femto access point and the gateway. The method further includes interacting with a default self organizing network server to perform location authorization, wherein the self organizing network server is configured to auto configured the Femto access point with preliminary radio parameters. The method also includes executing registration with a Femto gateway. The apparatus includes associated components for implementing the method described above.

### BACKGROUND OF THE INVENTION

1. Field of the Invention

The present invention is directed to a system and method for performing initial network entry procedures of an integrated or non-integrated femto access point (WFAP), wherein the WFAP is required to be authenticated by a WiMAX network prior to becoming active and operational.

2. Description of the Related Art

An embodiment of the WiMAX network architecture for femtocell systems is based on the WiMAX basic reference network model that differentiates the functional and business domains of network access providers (NAPs) from those of the network service providers (NSPs). FIG. 1 illustrates a prior art representation of network operators relationships in the WiMAX basic reference network model. Each NAP 102 is a business entity that provides WiMAX radio access infrastructure to one or more NSPs 104. Each NSP 104 is a business entity that manages users' subscriptions and provides IP connectivity and WiMAX services to subscribers according to negotiated service level agreements. To provide these services, each NSP 104 establishes contractual agreements with one or more NAPs 102. An NSP 104 may also establish roaming agreements with other NSPs and contractual agreements with third party application service providers (ASPS) 106 for providing IP services to subscribers.

Logical network entities for NSP 104 and NAP 102 include a connectivity serving network (CSN) and an access serving network (ASN), respectively. NAP 102 is deployed as one or more ASNs, which are composed of ASN gateways and base stations. NSP 104 is deployed as CSN and may include a home agent, authentication, authorization, and accounting (AAA), and other relevant servers and databases.

In a WiMAX network supporting a femtocell, a femto-NSP is responsible for the operation, authentication, and management of femto access points (WFAPs). The femto-NSP is logically separated from the conventional WiMAX NSPs responsible for mobile stations subscriptions, and it includes femto-AAA and femtocell management/self-organizing network (SON) subsystems. (See FIG. 2 below for further discussion of a WiMAX network supporting a femtocell)

The necessary procedure for attaching a WFAP to the WiMAX network is dependent on the physical composition of the WFAP associating with a broadband access device (e.g. DSL or Cable modem). The procedure for attaching the WFAP to the WiMAX network is also dependent on the Femto-NSP and the Femto-NAP network operational policies. If the WFAP is an integrated WFAP, and the broadband access operator is the same operator as the Femto-NSP, the Femto-NSP may prefer to by-pass the WFAP mutual authentication process with the WiMAX network during the initial network entry procedure. This is because the WFAP would have been authenticated and authorized during prior broadband access network entry procedures. As is known to those skilled in the art, an integrated WFAP integrates the WFAP functions with a broadband interface (e.g. DSL or Cable Modem) into a single physical device.

In a non-integrated WFAP, the WFAP and the broadband interface (e.g. DSL or Cable Modem) are maintained as two different physical devices. The connection between the WFAP and the broadband device is based on an opened interface. A Non-WiMAX Authenticated WFAP is an integrated WFAP which is not required to be authenticated over the WiMAX network by the Femto-NSP. Note that, an integrated WFAP does not imply that it is not required to be authenticated over the WiMAX network by the Femto-NSP. The decision to authenticate an integrated WFAP, by the Femto-NSP, is an operator based decision, depending on deployment. A WiMAX Authenticated WFAP can be an integrated WFAP or a non-integrated WFAP which is required to be authenticated by the Femto-NSP over the WiMAX network.

A problem to be solved by embodiments of the present invention is directed to the initial network entry procedures of an integrated or non-integrated WFAP which is required to be authenticated by the WiMAX network prior to becoming active and operational.

### SUMMARY OF THE INVENTION

An embodiment of the present invention is directed to the initial network entry procedures of the WFAP, integrated or non-integrated WFAP, which is required to be authenticated by the WiMAX network prior to becoming active and operational for associated Femto subscribers.

An embodiment of the present application is directed to a method and apparatus for implementing initial network entry procedures by a Femto access point which is required to be authenticated by the WiMAX network prior to becoming active and operational. The method includes implementing a DNS query to discover an associated server and gateway in an associated Femto network service provider domain and obtaining an IP address for the server and an IP address for the gateway. The method also includes authenticating the Femto access point with the associated Femto network service provider and establishing a secure IP tunnel between the Femto access point and the gateway. The method further includes interacting with a default self organizing network server to perform location authorization, wherein the self organizing network server is configured to auto configured the Femto access point with preliminary radio parameters. The method also includes executing registration with a Femto gateway. The apparatus includes associated components for performing the described method.

### BRIEF DESCRIPTION OF THE DRAWINGS

FIG. 1 illustrates a prior art representation of network operator relationships in a WiMAX basic reference network model;

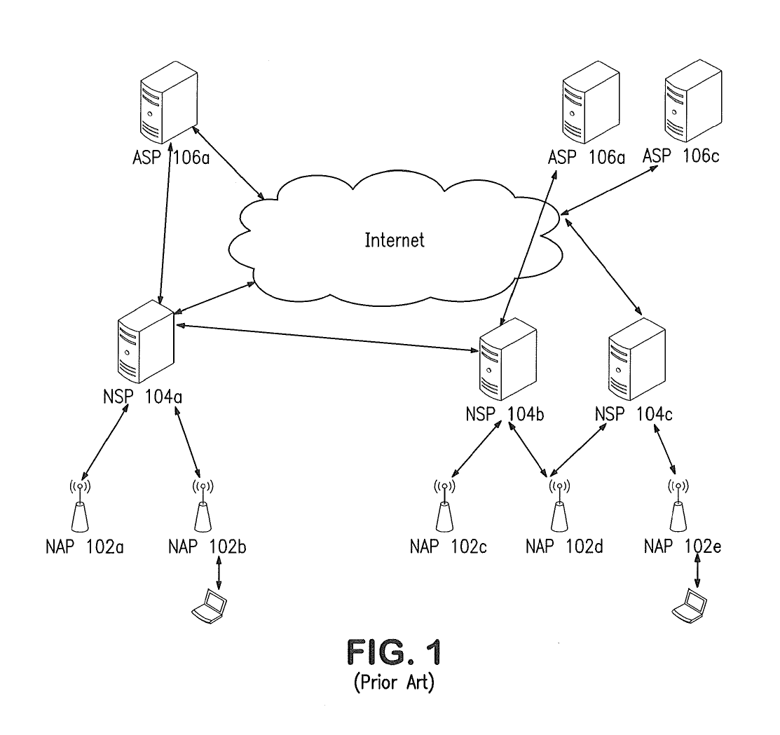

FIG. 2 illustrates an embodiment of WiMAX Femto network reference model with SON functions; and

FIG. 3 illustrates the steps implemented in an embodiment of the present invention.

### DETAILED DESCRIPTION OF EMBODIMENTS

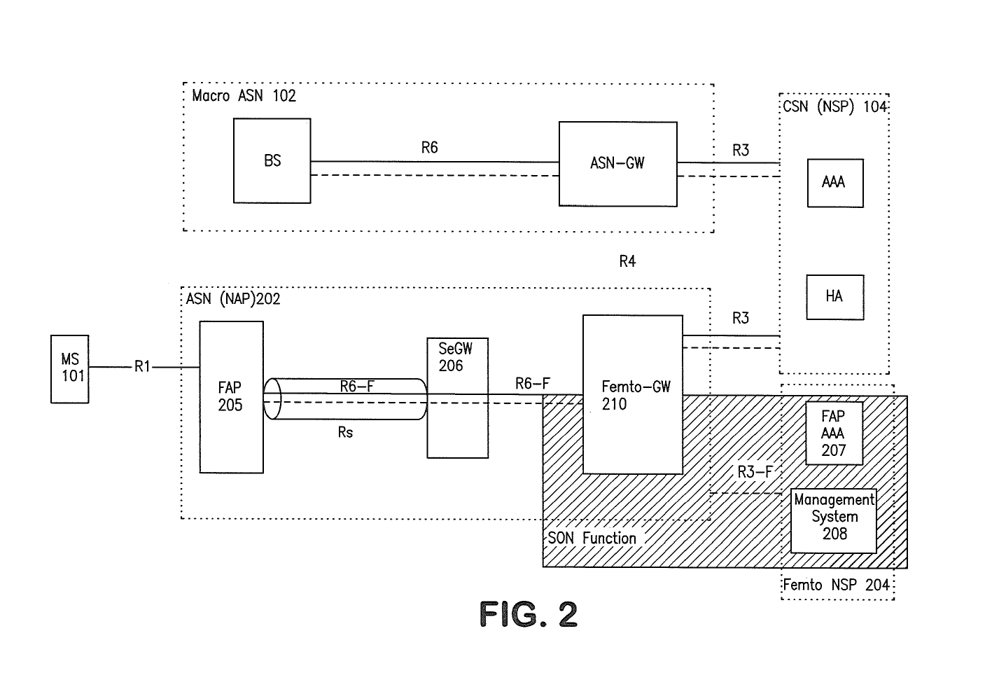

FIG. 2 illustrates an embodiment of WiMAX Femto network reference model with SON functions. As illustrated in FIG. 2, mobile station 201 is connected to the NAP 202 of the femtocell through femto access point (WFAP) 205. As noted above, a femto-NSP 204 is responsible for the operation, authentication, and management of WFAPs 205. Femto-NSP 204 is logically separated from the conventional WiMAX NSPs 104 which is responsible for mobile stations subscriptions. Femto-NSP 204 includes femto-AAA 207 and femtocell management/self-organizing network (SON) 208 subsystems.

According to an embodiment of the present invention, the general call flow for WiMAX authenticated WFAP 205 includes four phases: (1) Configuration Server Discovery Phase, (2) WFAP WiMAX Authentication Phase, (3) SON Location Authorization and preliminary radio system parameters Auto-Configuration Phase, and (4) Femto-GW Registration Phase.

In Phase 1 or the Configuration Server Discovery Phase, if a serving DHCP server and the serving SeGW 206, associated with WFAP 205 for the corresponding the Femto-NSP 207 have not been pre-configured to WFAP 205, the serving DHCP server and the serving SeGW 206 in the Femto-NSP domain is discovered via the support of DNS. Optionally, the SON server 208 may also be discovered in this phase. Note that, the network access identifier and the full qualified domain name (NAI/FQDN) would have been available for WFAP 205 to trigger the DNS query.

According to an embodiment of the invention, in this phase, WFAP 205 is connected to the IP broadband backhaul and uses DHCP specific procedure to acquire the IP address configured by the IP broadband operator to get access to the Internet. During this procedure, WFAP 205 may acquire the default SeGW 206, and optionally the default SON server's 208 IP, but it is out of WiMAX femto scope. WFAP 205 performs the discovery procedures for the associated serving DHCP server and serving SeGW 206 corresponding to Femto-NSP 204 via the support of DNS and WFAP 205 obtains the default serving SeGW's IP address, and the default serving DHCP server's IP address. WFAP 205 may optionally obtain the default serving SON Server's IP address.

As noted above, the NAI/FQDN would have been available for the WFAP to trigger the DNS query. It should be noted that if the WFAP obtains more than one SeGW IP addresses in this phase, then WFAP 205 may choose one of them as the default SeGW 206. Similarly, if WFAP 205 gets more than one SON server (SON Function) IP addresses in this phase, and then WFAP 205 may choose one of them as the default SON server 208.

In Phase 2 or the WFAP WiMAX Authentication Phase, WFAP 205 is authenticated by the Femto-NSP 204 through the support of SeGW 206 which hosts the Anchor Authenticator of WFAP 205. In this phase, through the support IKEv2, an IPSec tunnel is established between WFAP 205 and SeGW 206. In an embodiment of the present invention, in this phase, the WFAP connects to the default serving SeGW 206 which hosts the Anchor Authenticator of WFAP 205, and performs the authentication with the Femto-AAA 207. In the first step of this phase, the authentication process is performed between WFAP 205 and the Femto-AAA 207 via SeGW 206. Femto-AAA 207 checks whether WFAP 205 is an authorized subscriber based on the WFAP identification pre-assigned NAI. During the authentication procedure, Femto-AAA 207 may assign a SON server (SON Function) 208 to WFAP 205 if no SON server has been assigned to WFAP 205. The Femto-AAA may also assign a Femto-GW 210 to the WFAP. It should be noted that after Femto-AAA 207 assigns a SON server to WFAP 205, WFAP 205 uses the assigned SON server as the default SON server 208.

In the second step of this phase, after the successful completion of authentication between WFAP 205 and Femto-AAA 207, the IPSec tunnel establishment process is performed between WFAP 205 and SeGW 206. It should be noted that when WFAP 205 tries to connect to the default SeGW 206, the SeGW redirection procedure may happen (e.g. due to load balancing) and then WFAP 205 will connect to a new SeGW. It should also be noted that if WFAP 205 is a WiMAX non-authenticated WFAP, then the entire phase 2 can be omitted for WFAP 205.

In Phase 3 or the SON Location Authorization and preliminary radio system parameters Auto-Configuration Phase, an optional SON Server Discovery via the configuration provided by DHCP server or by Femto-AAA 207 may be performed. A WFAP Location Authorization, via the support of the SON function, and preliminary radio system parameters auto-configuration, via the support of the SON function, are also performed. According to an embodiment of the invention, in this phase, the WFAP performs SON server discovery and connects to the default SON server residing in the Femto-NSP 204 to perform the location authorization and to auto-configure the preliminary radio parameters.

In Step 1, the WFAP may obtain another IP address configured by Femto-NSP 204 to operate within the Femto-NSP 204 network domain. During this procedure, WFAP 205 may also be assigned a SON server 208 (SON function), if none has been assigned to the WFAP, in the Femto-NSP domain, and optionally, the serving Femto-GW 210 may also be assigned if none has been assigned. Note that if WFAP 205 does not need a Femto-NSP configured IP address, but if WFAP 205 obtains neither the default SON server (SON function) IP address nor the FQDN, WFAP 205 can also trigger the DHCP specific procedure with the serving DHCP server to acquire a SON server (SON function) IP address.

In Step 2, if WFAP 205 has the SON server FQDN, but not the IP address, then WFAP 205 can perform the DNS query procedure with the DNS server which resides in the Femto-NSP domain. During this procedure, WFAP 205 can get the SON server IP address.

In Step 3, WFAP 205 interacts with the default SON server in Femto-NSP 204 to perform the WFAP's location authorization, and based on the location information of WFAP 205, SON server 208 may assign a Femto-GW 210 to WFAP 205.

In Step 4, SON server 208 can auto-configure WFAP 205 with preliminary radio parameters. It should be noted that based on the location authorization, SON server 208 in the Femto-NSP can determine to which NAP WFAP 205 should connect. The location authorization function which is a part of the SON function should reside in the Femto-NSP domain.

In Phase 4 or the Femto-GW Registration Phase, (1) Femto-GW 210 assignment to the WFAP 205 can be specified by the configuration parameters provided by the serving DHCP server, by the serving Femto-AAA 207 or by the serving SON function; and (2) WFAP R6-F establishment with Femto-GW 210 is completed. In this stage, WFAP 205 connects to the appropriate Femto-GW 210 to execute the Femto-GW registration. After this stage, the WFAP will go into the base station mode.

In Step 1, NAP (SON function in the NAP) coordinates with the Femto-NSP (SON function in the NSP) to perform auto-configuration. In Step 2, WFAP 205 performs Femto-GW registration with the default Femto-GW 210. Then Femto-GW 210 becomes WFAP 205 serving Femto-GW. In addition, the Femto-GW may redirect WFAP 205 to another Femto-GW for the purpose of the load balancing or other optimization reasons. Note that during the Femto-GW registration, the Femto-GW may need to contact WFAP's SON function which resides both in NAP and Femto-NSP to exchange some information.

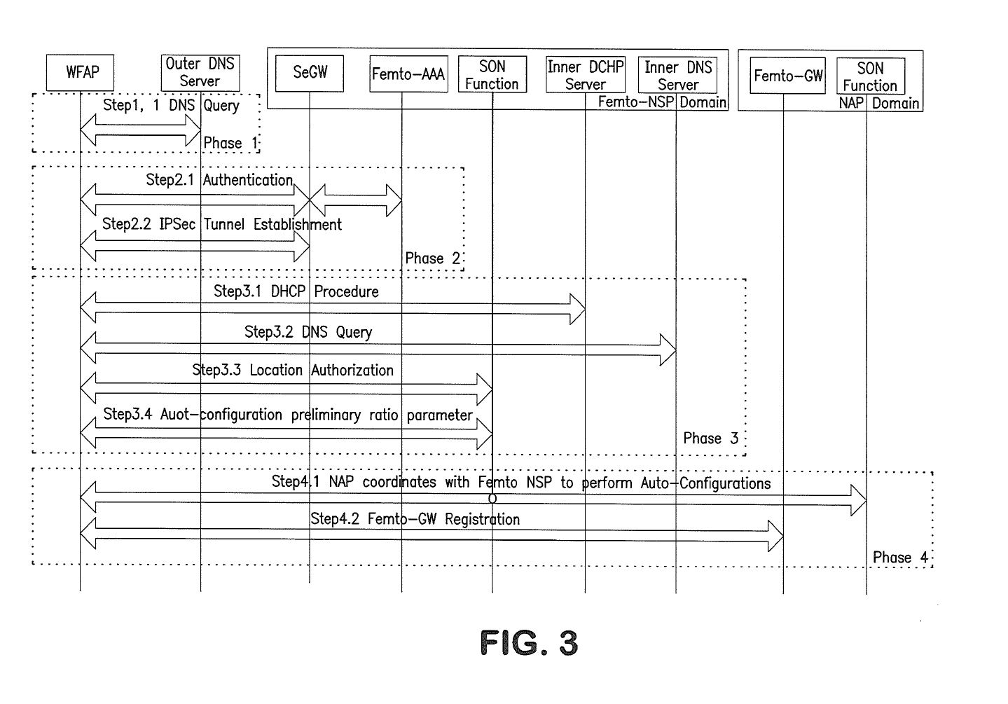

FIG. 3 illustrates the steps implemented in an embodiment of the present invention. In Step 1 of Phase 1, if a serving DHCP server and the serving SeGW 206 have not been pre-configured to WFAP 205, the serving DHCP server and the serving SeGW 206 in the Femto-NSP domain is discovered via the support of DNS.

In Step 1 of Phase 2, WFAP 205 is authenticated by the Femto-NSP 204 through the support of SeGW 20.6 which hosts the Anchor Authenticator of WFAP 205. In Step 2 of Phase 2, after the successful completion of authentication between WFAP 205 and Femto-AAA 207, the IPSec tunnel establishment process is performed between WFAP 205 and SeGW 206.

In Step 1 of Phase 3, WFAP 205 may obtain another IP address configured by Femto-NSP 204 to operate within the Femto-NSP 204 network domain. In Step 2 of Phase 3, if WFAP 205 has the SON server FQDN, but not the IP address, then WFAP 205 can perform the DNS query procedure with the DNS server which resides in the Femto-NSP domain. In Step 3 of Phase 3, WFAP 205 interacts with the default SON server in Femto-NSP 204 to perform the WFAP's location authorization, and based on the location information of WFAP 205, SON server 208 may assign a Femto-GW 210 to WFAP 205. In Step 4 of Phase 3, SON server 208 can auto-configure WFAP 205 with preliminary radio parameters.

In Step 1 of Phase 4, Femto-GW 210 assignment to the WFAP 205 can be specified by the configuration parameters provided by the serving DHCP server, by the serving Femto-AAA 207 or by the serving SON function. In Step 2 of Phase 4, WFAP 205 connects to the appropriate Femto-GW 210 to execute the Femto-GW registration.

Although the present invention has been shown and described with respect to certain embodiments, it should be understood by those skilled in the art that various modifications can be made to the inventive apparatus and the method of operating the same of the invention without departing from the scope and spirit of the invention. It is intended that the present invention cover modifications and variations of the inventive device and method provided they come within the scope of the appended claims and their equivalents.

1.-27. (canceled)

28. A method for implementing initial network entry procedures by a Femto access point which is required to be authenticated by the WiMAX network prior to becoming active and operational, comprising:
implementing a DNS query to discover an associated server in an associated Femto network service provider domain and obtaining an IP address for the server;
implementing the Femto access point for obtaining an IP address of a gateway from the server;
authenticating the Femto access point with the associated Femto network service provider and establishing a secure IP tunnel between the Femto access point and the gateway;
interacting with a self organizing network server to perform location authorization, wherein the self organizing network server is configured to auto configured the Femto access point with preliminary radio parameters or assigned by femto access point manage server;
assigning the Femto gateway to the Femto access point by configuration parameters provided one of a DHCP server, an authentication unit, or the self organizing network server; and
executing registration of the Femto access point with a Femto gateway.

29. The method of claim 28, wherein the implementing comprises selecting an IP address for one gateway if IP addresses for multiple gateways are obtained, wherein the gateway with the selected IP address is the default gateway for the Femto access point.

30. The method of claim 28, wherein the implementing comprises implementing the DNS query if the associated server and gateway have not been preconfigured to the Femto access point.

31. The method of claim 28, wherein the associated server discovered by the DNS query is a DHCP server and the associated gateway is a serving gateway.

32. The method of claim 28, wherein the self organizing network server is discovered via the DNS query.

33. The method of claim 28, wherein the authenticating comprises performing authentication between the Femto access point and an authentication unit through the gateway.

34. The method of claim 33, wherein the authenticating comprises checking by the authentication unit that Femto access point is an authorized subscriber based on pre-assigned information to the Femto access point.

35. The method of claim 33, wherein the authenticating comprises assigning, by the authentication unit, the self organizing network server to the Femto access point for use as a default self organizing network server.

36. The method of claim 33, wherein the authenticating comprises assigning, by the authentication unit, the Femto gateway to the Femto access point.

37. The method of claim 28, wherein the interacting comprises performing a self organizing network server discovery and connecting to a default self organizing network server.

38. The method of claim 37, wherein the connecting comprises obtaining another IP address configured by the Femto network service provider to operate within the Femto network service provider domain and obtaining the default self organizing network server, if none is already assigned to the Femto access point.

39. The method of claim 37, wherein the connecting comprises assigning the Femto gateway, if none is already assigned, to the Femto access point.

40. The method of claim 28, wherein the interacting comprises triggering at least one of a DHCP procedure or DNS query to obtain information associated with the default self organizing network server.

41. An apparatus configured to implement initial network entry procedures by a Femto access point which is required to be authenticated by the WiMAX network prior to becoming active and operational, comprising:
the Femto access point configured to implement a DNS query to discover an associated server and gateway in an associated Femto network service provider domain and to obtain an IP address for the server and an IP address for the gateway;
a Femto network service provider configured to authenticate the Femto access point through support of the gateway, wherein a secure IP tunnel is established between the Femto access point and the gateway; and
a default self organizing network server configured to perform location authorization for the Femto access point, wherein the self organizing network server is configured to auto configured the Femto access point with preliminary radio parameters,
wherein the Femto access point executes registration with a Femto gateway, and wherein the Femto gateway is assigned to the Femto access point by configuration parameters provided one of a DHCP server, an authentication unit, or the self organizing network server.

42. The apparatus of claim 41, wherein the Femto access point is configured to select an IP address for one gateway if IP addresses for multiple gateways are obtained, wherein the gateway with the selected IP address is the default gateway for the Femto access point.

43. The apparatus of claim 41, wherein the Femto access point is configured to implement the DNS query if the associated server and gateway have not been preconfigured to the Femto access point.

44. The apparatus of claim 41, wherein the associated server discovered by the DNS query is a DHCP server and the associated gateway is a serving gateway.

45. The apparatus of claim 41, wherein the self organizing network server is discovered via the DNS query.

46. The apparatus of claim 41, wherein an authentication unit of Femto network service provider is configured to check that Femto access point is an authorized subscriber based on pre-assigned information to the Femto access point.

47. The apparatus of claim 46, wherein the authentication unit is configured to assign the self organizing network server to the Femto access point for use as a default self organizing network server.

48. The apparatus of claim 46, wherein the authentication unit is configured to assign the Femto gateway to the Femto access point.

49. The apparatus of claim 41, wherein the Femto access point is configured to perform a self organizing network server discovery and connect to a default self organizing network server.

50. The apparatus of claim 49, wherein the Femto access point is configured to obtain another IP address configured by the Femto network service provider to operate within the Femto network service provider domain and obtain the default self organizing network server, if none is already assigned to the Femto access point.

51. An apparatus for implementing initial network entry procedures by a Femto access point which is required to be authenticated by the WiMAX network prior to becoming active and operational, comprising:
means for implementing a DNS query to discover an associated server and gateway in an associated Femto network service provider domain and obtaining an IP address for the server and an IP address for the gateway;
means for authenticating the Femto access point with the associated Femto network service provider and establishing a secure IP tunnel between the Femto access point and the gateway;
means for interacting with a default self organizing network server to perform location authorization, wherein the self organizing network server is configured to auto configured the Femto access point with preliminary radio parameters; and
means for executing registration with a Femto gateway; and
means for assigning the Femto gateway to the Femto access point by configuration parameters provided one of a DHCP server, an authentication unit, or the self organizing network server.

52. A method for implementing initial network entry procedures by a WiMAX non-authenticated Femto access point which is required to be authenticated by the WiMAX network prior to becoming active and operational, comprising:
implementing a DNS query to discover an associated server and gateway in an associated Femto network service provider domain and obtaining an IP address for the server and an IP address for the gateway;
interacting with a default self organizing network server to perform location authorization, wherein the self organizing network server is configured to auto configured the Femto access point with preliminary radio parameters;
executing registration with a Femto gateway; and
assigning the Femto gateway to the Femto access point by configuration parameters provided one of a DHCP server, an authentication unit, or the self organizing network server.
